(19) United States
(12) Patent Application Publication
(10) Pub. No.: US 2022/0131318 A1
(43) Pub. Date: Apr. 28, 2022

(54) HIGH-SPEED TRANSMISSION CABLE AND CABLE END CONNECTOR INCLUDING THE SAME

(71) Applicant: BELLWETHER ELECTRONIC CORP., Taoyuan City (TW)

(72) Inventor: Kuan-Wu Chen, Taoyuan City (TW)

(21) Appl. No.: 17/451,668

(22) Filed: Oct. 21, 2021

Related U.S. Application Data
(60) Provisional application No. 63/104,523, filed on Oct. 23, 2020.

(51) Int. Cl. H01R 13/6471; H01R 12/59; H01R 12/61; H01B 11/08

(52) U.S. Cl. CPC H01R 13/6471; H01B 11/08; H01R 12/61; H01R 12/592

(57) ABSTRACT

A high-speed transmission cable and a cable end connector including the same are provided. The cable end connector includes a connector body and the high-speed transmission cable that includes at least one cable assembly, at least one transmission line, and an insulating material. The at least one cable assembly includes multiple ground wires and multiple differential pairs that are arranged at fixed intervals and in parallel with each other, an insulating layer, and at least one shielding layer. Each of the differential pairs includes two signal wires that are adjacently arranged, and is located between two adjacent ones of the ground wires. The insulating layer covers the ground wires and the differential pairs. The at least one shielding layer is located at an outer side of the insulating layer. The insulating material covers the at least one cable assembly and the at least one transmission line.

### CROSS-REFERENCE TO RELATED PATENT APPLICATION

This application claims priority to the U.S. Provisional Patent Application Ser. No. 63/104,523 filed on Oct. 23, 2020, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a cable structure, and more particularly to a high-speed transmission cable and a cable end connector including the same.

### BACKGROUND OF THE DISCLOSURE

Referring to FIG. 1, FIG. 1 is a schematic view of a conventional high-speed transmission cable. In the conventional technology, cable twisting is used to offset a magnetic field effect generated by cable wires and to reduce transmission signal degradation caused by crosstalk. As shown in FIG. 1, when two high-speed wires are twisted together, an arrangement of such a high-speed wire pair (such as L1, L2 of FIG. 1) is not subject to control, and positions of the high-speed wires require adjustment when the high-speed wire pair is to be connected to a pad on a circuit board. As a result, there is no length match in the high-speed wire pair, and an intra-pair skew between differential pair signals will occur, thereby affecting characteristics of data transmission (e.g., parameters of common-mode output (SCD21)), generating common-mode noise signals, and causing electromagnetic interference (EMI) problems.

Referring to FIG. 2, FIG. 2 is a schematic sectional view of another conventional high-speed transmission cable. An inside of such an electrical cable structure is configured to include a plurality of power wires, ground wires, and high-speed wire pairs (as shown by C1, C2, C3 in FIG. 2). As illustrated, there are length differences between the high-speed wire pairs C1, C2, C3, which not only cause an inter-pair skew between a plurality of differential pairs, but also affect the characteristics of data transmission.

Therefore, how to overcome the above-mentioned deficiencies through an improvement in the structural design of cables, so as to prevent the skew between electrical cables from affecting characteristics of high-frequency signals and even causing an error in transmitted data, has become one of the important issues to be solved in the related art.

### SUMMARY OF THE DISCLOSURE

In response to the above-referenced technical inadequacies, the present disclosure provides a high-speed transmission cable and a cable end connector including the same.

In one aspect, the present disclosure provides a high-speed transmission cable, which includes at least one cable assembly, at least one transmission line, and an insulating material. The at least one cable assembly includes a plurality of ground wires and a plurality of differential pairs that are arranged at fixed intervals and in parallel with each other, an insulating layer, and at least one shielding layer. Each of the differential pairs includes two signal wires that are adjacently arranged, and is located between two adjacent ones of the ground wires. The insulating layer is used for covering the ground wires and the differential pairs, and the at least one shielding layer is located at an outer side of the insulating layer. The insulating material covers the at least one cable assembly and the at least one transmission line.

In another aspect, the present disclosure provides a high-speed transmission cable, which includes at least one cable assembly and an insulating material. The at least one cable assembly includes a first flat cable and a second flat cable that are arranged side by side. The first flat cable and the second flat cable each include a plurality of wires that are arranged at fixed intervals and in parallel with each other, an insulating layer, and at least one shielding layer. The insulating layer covers the wires, and the at least one shielding layer is located at an outer side of the insulating layer. The insulating material is used for covering the first flat cable and the second flat cable.

In yet another aspect, the present disclosure provides a cable end connector, which includes a connector body and a high-speed transmission cable. The connector body has a ground structure. The high-speed transmission cable includes at least one cable assembly, at least one power transmission line, and an insulating material. The at least one cable assembly includes a plurality of wires that are arranged at fixed intervals and in parallel with each other, an insulating layer, and at least one shielding layer. The insulating layer is used for covering the wires, and the at least one shielding layer is located at an outer side of the insulating layer and is electrically connected to the ground structure. The at least one power transmission line is arranged outside the at least one cable assembly. The insulating material covers the at least one cable assembly and the at least one power transmission line.

Therefore, in the high-speed transmission cable provided by the present disclosure, by virtue of “the at least one cable assembly including the plurality of ground wires and the plurality of differential pairs that are arranged at fixed intervals and in parallel with each other” and “each of the differential pairs being located between two adjacent ones of the ground wires”, an issue of electrical cables not having an equal length after being twisted together can be avoided, so that contact point positions of the electrical cables when being connected to a pad on a circuit board can be more definite.

Further, in the cable end connector including the high-speed transmission cable provided by the present disclosure, by virtue of “the at least one cable assembly including the plurality of wires that are arranged at fixed intervals and in parallel with each other, the insulating layer, and the at least one shielding layer, the insulating layer being used for covering the wires, and the at least one shielding layer being located at the outer side of the insulating layer and being electrically connected to the ground structure”, the issue of the electrical cables not having an equal length after being twisted together can be avoided, so that the contact point positions of the electrical cables when being connected to the pad on the circuit board can be more definite.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a conventional high-speed transmission cable;

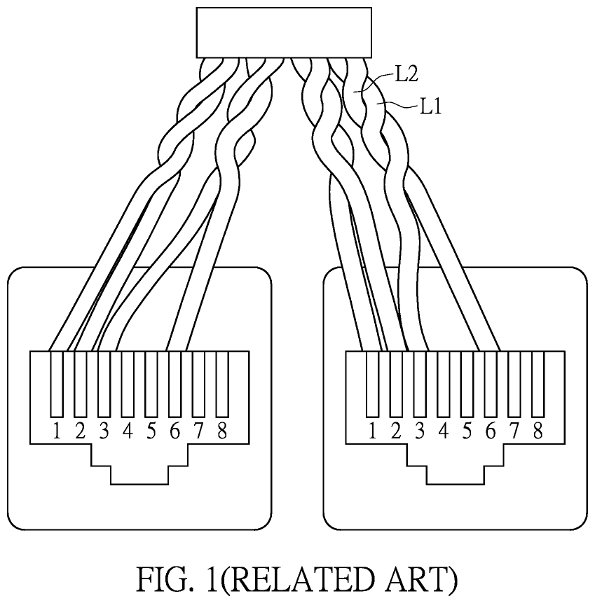

FIG. 2 is a schematic sectional view of another conventional high-speed transmission cable;

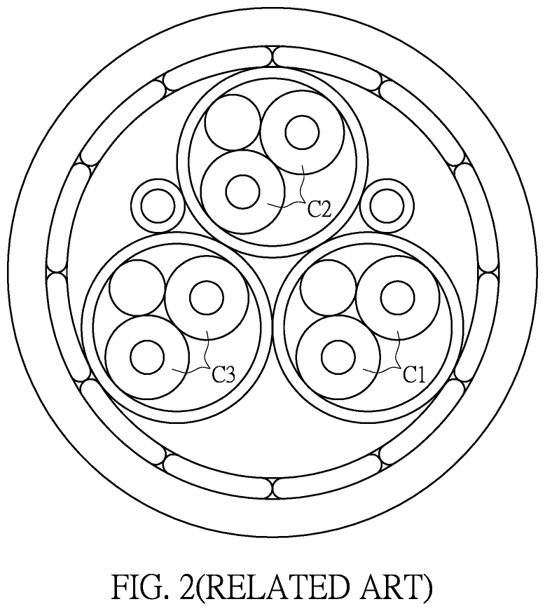

FIG. 3 is a schematic sectional view of a high-speed transmission cable according to a first embodiment of the present disclosure;

FIG. 4 is a schematic sectional view of a high-speed transmission cable according to a second embodiment of the present disclosure;

FIG. 5 is a schematic sectional view of a high-speed transmission cable according to a third embodiment of the present disclosure; and

FIG. 6 is a schematic view of a cable end connector including a high-speed transmission cable according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

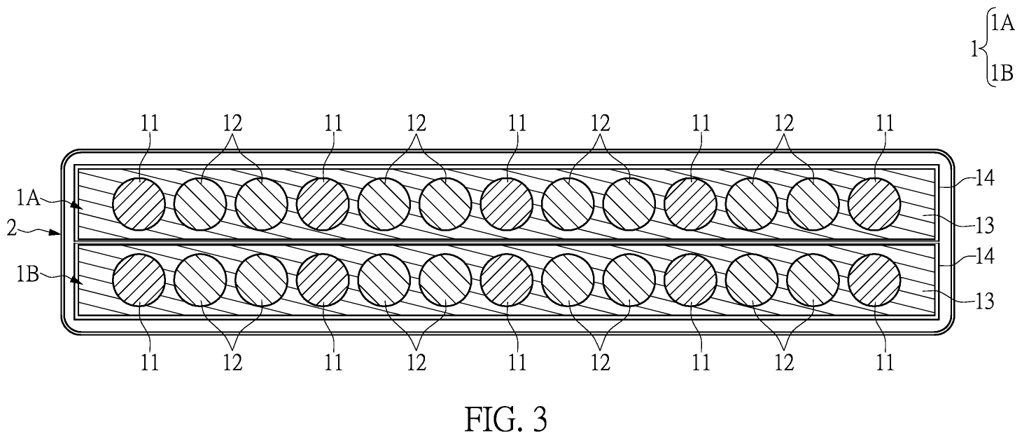

Reference is made to FIG. 3, which is a schematic sectional view of a high-speed transmission cable according to a first embodiment of the present disclosure. The high-speed transmission cable provided in the first embodiment of the present disclosure includes at least one cable assembly 1 and an insulating material 2. The insulating material 2 covers the at least one cable assembly 1, and the insulating material 2 has insulation and protection functions. The at least one cable assembly 1 can be a flat cable having a flat shape. In the present embodiment, the at least one cable assembly 1 includes a first flat cable 1A and a second flat cable 1B that have a flat shape. Each of the flat cables (1A or 1B) includes a plurality of wires that are arranged at fixed intervals and in parallel with each other. The wires include a plurality of ground wires 11 and a plurality of differential pairs. Each of the differential pairs includes two signal wires 12 that are adjacently arranged, and is located between two adjacent ones of the ground wires 11. In this way, in the present disclosure, transmission of differential signals can be carried out through the two signal wires 12 of the differential pair. In addition, each of the flat cables (i.e., the first flat cable 1A or the second flat cable 1B) includes an insulating layer 13. That is to say, the insulating layer 13 within the first flat cable 1A covers the wires of the first flat cable 1A, and the insulating layer 13 within the second flat cables 1B covers the wires of the second flat cable 1B. Each of the flat cables (1A or 1B) further includes at least one shielding layer 14, and the at least one shielding layer 14 is located at an outer side of the insulating layer 13. In the present embodiment, each of the first flat cable 1A and the second flat cable 1B includes one shielding layer 14, each of which covers the wires of the corresponding flat cable. To be more specific, from a sectional view of each of the flat cables (1A or 1B), various cover materials used for covering the ground wires 11 and the differential pairs are arranged in an order of the insulating material 2, the shielding layer 14, and the insulating layer 13 from outside to inside. However, it should be noted that in other embodiments, the at least one shielding layer 14 does not need to completely cover an outer surface of all the wires, but can partially cover the flat cable (1A or 1B). For example, the at least one shielding layer 14 can cover an upper surface and/or a lower surface of the flat cable (1A or 1B), and a side surface of the flat cable (1A or 1B) can be not covered.

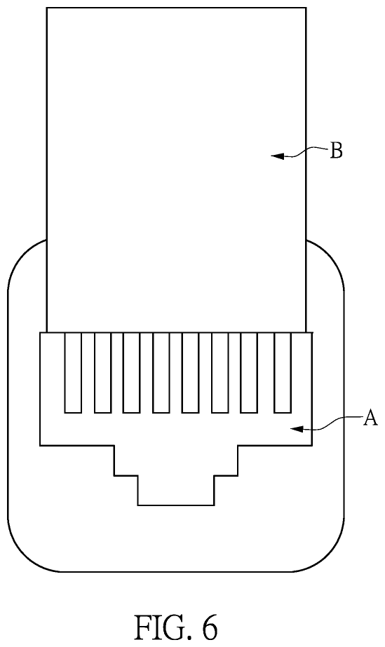

Reference is made to FIG. 6, which is a schematic view of a cable end connector including a high-speed transmission cable according to the present disclosure. The cable end connector provided by the present disclosure includes a connector body A and a high-speed transmission cable B. A structure of the high-speed transmission cable B is configured to be similar to that of the high-speed transmission cable shown in FIG. 3, and will not be reiterated herein. At least one end of the high-speed transmission cable B is connected to the connector body A, and the at least one shielding layer 14 of at least one of the flat cables is in physical contact with a ground structure (not shown in the figures) of the connector body A, so as to provide a shielding function. Preferably, the at least one shielding layer 14 of each of the flat cables is electrically connected to or is in physical contact with the ground structure of the connector body A. When the high-speed transmission cable B includes two or more than two of the flat cables, the at least one shielding layer 14 of one of the flat cables is preferably electrically connected to the at least one shielding layer 14 of another one of the flat cables. For example, a surface of the at least one shielding layer 14 of one flat cable and that of the at least one shielding layer 14 of another flat cable are partially attached to each other. In addition, the at least one shielding layer 14 can cover a partial area or a whole area of the flat cable (such as covering an upper surface, a lower surface, or completely surrounding the entire flat cable), so as to provide a shielding function. Moreover, each of the flat cables can also include a protective layer (not shown in the figures), which covers an outer side surface of the at least one shielding layer 14 and protects the at least one shielding layer 14. At this time, multiple ones of the at least one shielding layer 14 can be electrically connected to each other through the ground structure of the connector body A.

For example, the insulating material 2 is selected from the group consisting of polyvinyl chloride (PVC), polypropylene (PP), and ethylene propylene rubber (EPR). However, the present disclosure is not limited to examples mentioned above. A material of the insulating layer 13 can be, for example but not limited to, a polyester insulating material (PET). As shown in a sectional view of FIG. 3, sections of the ground wires 11 and the signal wires 12 are exemplified as having a circular shape, but the present disclosure is not limited thereto. For example, the first flat cable 1A and the second flat cable 1B that have a flat shape are formed by the ground wires 11, the signal wires 12, and the insulating layer 13, and can be a flexible flat cable (FFC) or a flexible printed circuit (FPC).

More specifically, in the high-speed transmission cable provided by the present disclosure, a quantity of the flat cables that the at least one cable assembly 1 includes is not limited. For example, the at least one cable assembly 1 shown in FIG. 3 includes the first flat cable 1A and the second flat cable 1B. The first flat cable 1A and the second flat cable 1B are arranged side by side, and the insulating material 2 covers an outer side of the first flat cable 1A and the second flat cable 1B. At least one of the first flat cable 1A and the second flat cable 1B includes the ground wires 11 and the differential pairs (including the two adjacently arranged signal wires 12) that are arranged at fixed intervals and in parallel with each other, and each of the differential pairs is located between two adjacent ones of the ground wires 11. The first flat cable 1A and the second flat cable 1B each include one insulating layer 13, which covers the ground wires 11 and the differential pairs within the first flat cable 1A, and covers the ground wires 11 and the differential pairs within the second flat cable 1B.

### Second Embodiment

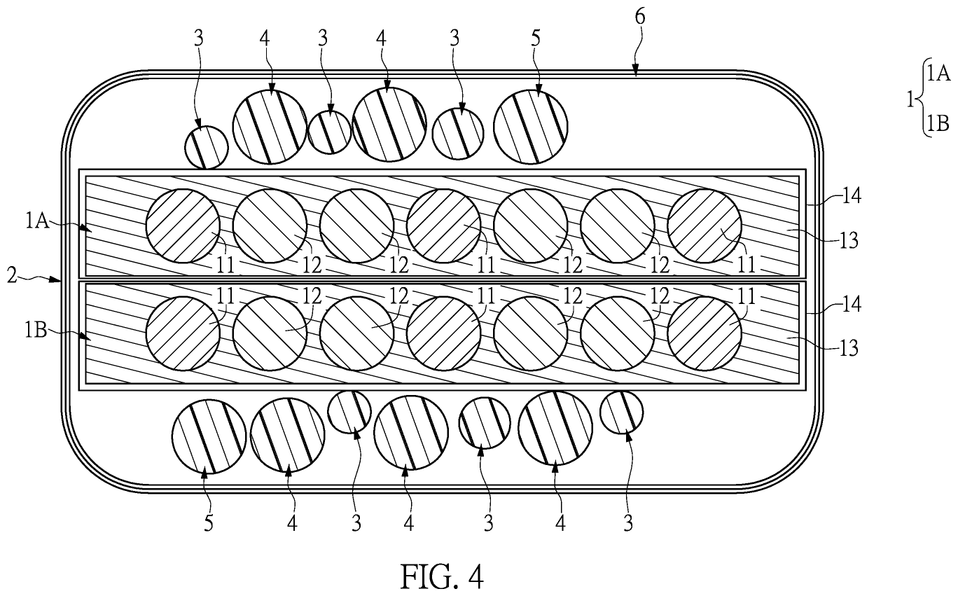

Reference is made to FIG. 4, which is a schematic sectional view of a high-speed transmission cable according to a second embodiment of the present disclosure. In the present embodiment, the high-speed transmission cable includes a first flat cable 1A and a second flat cable 1B that are arranged side by side, and an insulating material 2 that covers the first flat cable 1A and the second flat cable 1B. The first flat cable 1A and the second flat cable 1B each include a plurality of wires that are arranged at fixed intervals and in parallel with each other. The wires include a plurality of ground wires 11 and a plurality of differential pairs, each of the differential pairs includes two signal wires 12 that are adjacently arranged, and each of the differential pairs is located between two adjacent ones of the ground wires 11. The first flat cable 1A and the second flat cable 1B each include an insulating layer 13, which covers the ground wires 11 and the differential pairs within the first flat cable 1A and covers those within the second flat cable 1B. Material compositions of the insulating material 2 and the insulating layer 13 are the same as those described in the previous embodiment, which will not be reiterated herein. Further, the first flat cable 1A and the second flat cable 1B each include one shielding layer 14, and the two shielding layers 14 respectively cover the wires of the first flat cable 1A and the wires of the second flat cable 1B.

Specifically, the high-speed transmission cable of the present embodiment further includes at least one of a single-ended transmission line 3, a power transmission line 5, and a ground transmission line 4. The at least one of the single-ended transmission line 3, the power transmission line 5, and the ground transmission line 4 is arranged outside the shielding layer 14, or is not arranged at an inside of at least one cable assembly 1 (i.e., the first flat cable 1A and the second flat cable 1B). For example, as shown in FIG. 4, the at least one of the single-ended transmission line 3, the power transmission line 5, and the ground transmission line 4 is arranged between the insulating material 2 and the at least one cable assembly 1, or is arranged between the first flat cable 1A and the second flat cable 1B. The at least one of the single-ended transmission line 3, the power transmission line 5, and the ground transmission line 4 is arranged at a periphery of the first flat cable 1A and the second flat cable 1B. It should be noted that a quantity of each of the single-ended transmission line 3, the power transmission line 5, and the ground transmission line 4 is not limited in the present disclosure. More specifically, each transmission line of the single-ended transmission line 3, the ground transmission line 4, and the power transmission line 5 can include a wire core and an insulating outer layer that covers the wire core (not shown in the figures). Preferably, a shielding outer layer (not shown in the figures) is further included, and the shielding outer layer covers the insulating outer layer.

Moreover, the high-speed transmission cable of the present embodiment further includes a shielding material 6 mainly used for electromagnetic interference (EMI) shielding. That is, the shielding material 6 allows the high-speed transmission cable to be isolated from the surrounding electronic components, so as to prevent electromagnetic interference therebetween. The shielding material 6 is arranged on an inner surface of the insulating material 2. Specifically, the shielding material 6 covers the first flat cable 1A, the second flat cable 1B, and the at least one of the single-ended transmission line 3, the power transmission line 5, and the ground transmission line 4. The insulating material 2 covers the shielding material 6. To be more specific, from a sectional view of each of the flat cables (1A, 1B), various cover materials used for covering the ground wires 11 and the differential pairs are arranged in an order of the insulating material 2, the shielding material 6, the shielding layer 14, and the insulating layer 13 from outside to inside. In addition, the shielding layer 14 and the shielding material 6 can be, for example, a thin layer of an electrically conductive material. The electrically conductive material can be, for example but not limited to, copper and aluminum.

### Third Embodiment

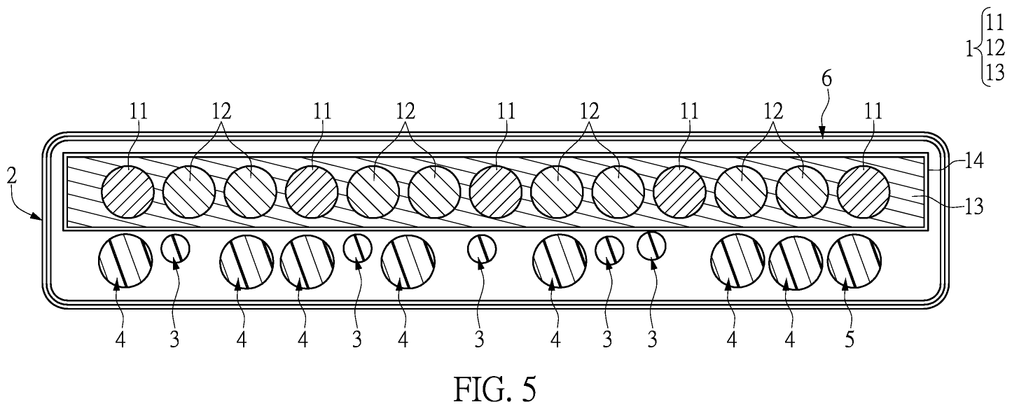

Reference is made to FIG. 5, which is a schematic sectional view of a high-speed transmission cable according to a third embodiment of the present disclosure. In the present embodiment, the high-speed transmission cable includes a cable assembly 1 and an insulating material 2 that covers the cable assembly 1. The cable assembly 1 is a flat cable, which includes a plurality of ground wires 11 and a plurality of differential pairs that are arranged at fixed intervals and in parallel with each other. Each of the differential pairs includes two signal wires 12 that are adjacently arranged, and is located between two adjacent ones of the ground wires 11. The cable assembly 1 further includes an insulating layer 13, and the insulating layer 13 covers the ground wires 11 and the differential pairs. Material compositions of the insulating material 2 and the insulating layer 13 are the same as those described in the previous embodiment, which will not be reiterated herein. Specifically, the high-speed transmission cable of the present embodiment further includes at least one of a single-ended transmission line 3, a power transmission line 5, and a ground transmission line 4, which is arranged between the insulating material 2 and the insulating layer 13. The at least one of the single-ended transmission line 3, the power transmission line 5, and the ground transmission line 4 is arranged at a periphery of the cable assembly 1. It should be noted that a quantity of each of the single-ended transmission line 3, the power transmission line 5, and the ground transmission line 4 is not limited in the present disclosure. Moreover, the high-speed transmission cable of the present embodiment further includes a layer of a shielding material 6 made of copper and/or aluminum, which is mainly used for electromagnetic interference (EMI) shielding. That is, the shielding material 6 protects the high-speed transmission cable from electromagnetic interference of the surrounding electronic components. The shielding material 6 is arranged on an inner surface of the insulating material 2. In detail, the shielding material 6 covers the cable assembly 1 and the at least one of the single-ended transmission line 3, the power transmission line 5, and the ground transmission line 4, and the insulating material 2 covers the shielding material 6. In addition, the cable assembly 1 further includes at least one shielding layer 14. The at least one shielding layer 14 is used for covering the cable assembly 1, and also has the function of electromagnetic interference (EMI) shielding. The at least one shielding layer 14 is arranged between the insulating layer 13 and the shielding material 6. From a sectional view of the cable assembly 1, various cover materials used for covering the ground wires 11 and the differential pairs are arranged in an order of the insulating material 2, the shielding material 6, the at least one shielding layer 14, and the insulating layer 13 from outside to inside.

### Beneficial Effects of the Embodiments

In conclusion, in the high-speed transmission cable provided by the present disclosure, by virtue of “the at least one cable assembly 1 including the plurality of ground wires 11 and the plurality of differential pairs that are arranged at fixed intervals and in parallel with each other” and “each of the differential pairs being located between two adjacent ones of the ground wires 11”, an issue of electrical cables not having an equal length after being twisted together can be avoided, so that contact point positions of the electrical cables when being connected to a pad on a circuit board can be more definite.

Further, in the cable end connector including the high-speed transmission cable provided by the present disclosure, by virtue of “the at least one cable assembly 1 including the plurality of wires that are arranged at fixed intervals and in parallel with each other, the insulating layer 13, and the at least one shielding layer 14, the insulating layer 13 being used for covering the wires, and the at least one shielding layer 14 being located at the outer side of the insulating layer 13 and being electrically connected to the ground structure”, the issue of the electrical cables not having an equal length after being twisted together can be avoided, so that the contact point positions of the electrical cables when being connected to the pad on the circuit board can be more definite.

More specifically, in the high-speed transmission cable provided by the present disclosure, the ground wires 11 and the differential pairs of at least one of the flat cables can be arranged at fixed intervals and in parallel with each other, and each of the differential pairs is located between two adjacent ones of the ground wires 11. In this way, the at least one cable assembly 1 is formed into a cable structure that is equivalent to the flexible flat cable (FFC) or the flexible printed circuit (FPC), instead of a twisted cable structure in the conventional technology. That is to say, since the two signal wires 12 are of equal length and are closely arranged with each other, a phase difference can be reduced to carry out the transmission of differential signals, and generation of common-mode noise signals can be suppressed.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A high-speed transmission cable, comprising:
at least one cable assembly, wherein the at least one cable assembly includes a plurality of ground wires and a plurality of differential pairs that are arranged at fixed intervals and in parallel with each other, an insulating layer, and at least one shielding layer; wherein each of the differential pairs includes two signal wires that are adjacently arranged, and is located between two adjacent ones of the ground wires; wherein the insulating layer is used for covering the ground wires and the differential pairs, and the at least one shielding layer is located at an outer side of the insulating layer;
at least one transmission line; and
an insulating material used for covering the at least one cable assembly and the at least one transmission line.

2. The high-speed transmission cable according to claim 1, further comprising a shielding material arranged on an inner surface of the insulating material, wherein the shielding material covers the at least one cable assembly and the at least one transmission line.

3. The high-speed transmission cable according to claim 1, wherein the insulating material is selected from the group consisting of polyvinyl chloride, polypropylene, and ethylene propylene rubber.

4. The high-speed transmission cable according to claim 1, wherein the at least one cable assembly is a flexible flat cable or a flexible printed circuit.

5. The high-speed transmission cable according to claim 1, wherein the at least one transmission line is a single-ended transmission line, a power transmission line or a ground transmission line.

6. The high-speed transmission cable according to claim 1, wherein the at least one transmission line is arranged between the insulating material and the at least one cable assembly.

7. The high-speed transmission cable according to claim 1, wherein the at least one transmission line includes:
a wire core; and
an insulating outer layer used for covering the wire core.

8. A high-speed transmission cable, comprising:
at least one cable assembly, wherein the at least one cable assembly includes a first flat cable and a second flat cable that are arranged side by side; wherein the first flat cable and the second flat cable each include a plurality of wires that are arranged at fixed intervals and in parallel with each other, an insulating layer, and at least one shielding layer; wherein the insulating layer covers the wires, and the at least one shielding layer is located at an outer side of the insulating layer; and
an insulating material used for covering the first flat cable and the second flat cable.

9. The high-speed transmission cable according to claim 8, wherein the at least one shielding layer of the first flat cable is electrically connected to the at least one shielding layer of the second flat cable.

10. The high-speed transmission cable according to claim 8, further comprising at least one of a single-ended transmission line, a power transmission line, and a ground transmission line, wherein the at least one of the single-ended transmission line, the power transmission line, and the ground transmission line is arranged between the insulating material and the insulating layer or is arranged between the first flat cable and the second flat cable.

11. The high-speed transmission cable according to claim 10, further comprising a shielding material arranged on an inner surface of the insulating material, wherein the shielding material covers the first flat cable, the second flat cable, and the at least one of the single-ended transmission line, the power transmission line, and the ground transmission line.

12. The high-speed transmission cable according to claim 8, wherein the insulating material is selected from the group consisting of polyvinyl chloride, polypropylene, and ethylene propylene rubber.

13. The high-speed transmission cable according to claim 8, wherein the first flat cable and the second flat cable are a flexible flat cable or a flexible printed circuit.

14. A cable end connector, comprising:
a connector body having a ground structure; and
a high-speed transmission cable, wherein the high-speed transmission cable includes:
at least one cable assembly, wherein the at least one cable assembly includes a plurality of wires that are arranged at fixed intervals and in parallel with each other, an insulating layer, and at least one shielding layer; wherein the insulating layer is used for covering the wires, and the at least one shielding layer is located at an outer side of the insulating layer and is electrically connected to the ground structure;
at least one power transmission line, wherein the at least one power transmission line is not arranged at an inside of the at least one cable assembly; and
an insulating material used for covering the at least one cable assembly and the at least one power transmission line.

15. The cable end connector according to claim 14, wherein the at least one cable assembly further includes a protective layer that covers an outer side surface of the at least one shielding layer.

16. The cable end connector according to claim 14, wherein the high-speed transmission cable further includes a shielding material, and the shielding material is arranged on an inner surface of the insulating material, so as to cover the at least one cable assembly and the at least one power transmission line.

17. The cable end connector according to claim 16, wherein the at least one cable assembly further includes a protective layer that covers an outer side surface of the at least one shielding layer.

18. The cable end connector according to claim 14, wherein the at least one power transmission line includes a wire core and an insulating outer layer that covers the wire core.

19. The cable end connector according to claim 14, wherein the at least one cable assembly includes a first flat cable and a second flat cable that are arranged side by side; wherein the first flat cable and the second flat cable each include the wires that are arranged at fixed intervals and in parallel with each other, the insulating layer, and the at least one shielding layer; wherein the insulating layer covers the wires, the at least one shielding layer is located at the outer side of the insulating layer, and the at least one shielding layer of the first flat cable is electrically connected to the at least one shielding layer of the second flat cable.
